(19) United States
(12) Patent Application Publication
(10) Pub. No.: US 2026/0367986 A1
(43) Pub. Date: Nov. 19, 2026

(54) RESOURCE-BASED RATE LIMITING FOR LARGE LANGUAGE MODEL APPLICATIONS

(71) Applicant: Red Hat, Inc., Raleigh, NC (US)

(72) Inventors: Paolo Antinori, Milan (IT); Andrew David Mackenzie, Madrid (ES)

(21) Appl. No.: 19/206,754

(22) Filed: May 13, 2025

(51) Int. Cl. G06F 9/50

(52) U.S. Cl. CPC G06F 9/505; G06F 9/5044; G06F 2209/5022; G06F 2209/503

(57) ABSTRACT

A method, a system, and a non-transitory computer-readable medium are provided. The method includes receiving, from a client device, an initial inquiry associated with a primary large language model (LLM). The method includes redirecting, by a processing device, the initial inquiry to a secondary LLM in response to determining that a computing resource associated with the primary LLM fails to satisfy a threshold. The method includes obtaining, from the secondary LLM, an interim response to the initial inquiry, the interim response including a request for extra information associated with the initial inquiry. The method includes transmitting the interim response to the client device.

### TECHNICAL FIELD

Aspects of the present disclosure relate to computer systems, and particularly to resource-based rate limiting for large language model (LLM) applications.

### BACKGROUND

Generative artificial intelligence (AI) applications have been increasingly adopted in computer systems to generate content in response to user inquiries. A common application is chatbot, which is a software tool that is configured to have conversations with users in human language. The generation of content typically uses LLMs, which are trained and deployed on hardware and software with complex architectures that consume considerable amount of computing resources.

### BRIEF DESCRIPTION OF THE DRAWINGS

The described implementations and the advantages thereof may best be understood by reference to the following description taken in conjunction with the accompanying drawings. These drawings in no way limit any changes in form and detail that may be made to the described implementations without departing from the spirit and scope of the disclosure.

FIG. 1 is a block diagram that illustrates an example computer system for executing an AI application to respond to an inquiry, according to some implementations.

FIGS. 2A and 2B each illustrate an example scenario in which the computer system of FIG. 1 generates a response to an inquiry, according to some implementations.

FIG. 3 is a flowchart that illustrates example operations of a computing device executing an AI application with a client device, according to some implementations.

FIG. 4 is a flowchart that illustrates an example method, according to some implementations.

FIG. 5 is a block diagram of an example computing device that may perform one or more of the operations described herein, according to some implementations.

### DETAILED DESCRIPTION

In a common generative AI application, a user sends an inquiry in natural language from a client device, such as a mobile device or personal computer, to an AI computing device, such as an AI server configured to process the inquiry. The inquiry may include phrases and sentences in human language, as if the user was messaging another human, and may request the AI computing device to provide content also in human language. The AI computing device processes the inquiry by converting the inquiry into one or more tokens and sending the tokens to an LLM, which often includes a neural network with complex software and hardware architectures and a large number of configurations. When many users send inquiries to the AI computing device in the same time period, the AI computing device may face a shortage of available computing resources for processing the large number of tokens and may implement a rate limiting mechanism that sets a limit on the number of inquiries that the LLM may process in a given period while delaying the processing of other inquiries. As a result, some users may experience delayed response to inquiries, which may lead to unsatisfactory user experience. In some scenarios, such as chatbot-based customer service applications, the delayed response may further lead to the user’s termination of the conversation and potentially cause a loss of business.

This disclosure provides techniques that address the challenges described above. As described below in detail, one or more implementations of this disclosure improve the rate-limiting technology for generative AI applications by redirecting the user inquiry to a secondary LLM to continue the conversation when the primary LLM is unavailable. According to some aspects, a computing device, upon receiving an initial inquiry associated with a primary LLM from a client device, redirects the initial inquiry to a secondary LLM in response to determining that a computing resource associated with the primary LLM fails to satisfy a threshold. The computing device obtains, from the secondary LLM, an interim response to the initial inquiry. The interim response includes a request for extra information associated with the initial inquiry. The computing device then transmits the interim response to the client device. Because of the features of the implementations, the user may feel the conversation is proceeding naturally with reduced interruption compared with existing rate limiting mechanisms. As such, the user may have improved experience and may be more willing to stay engaged in the AI application.

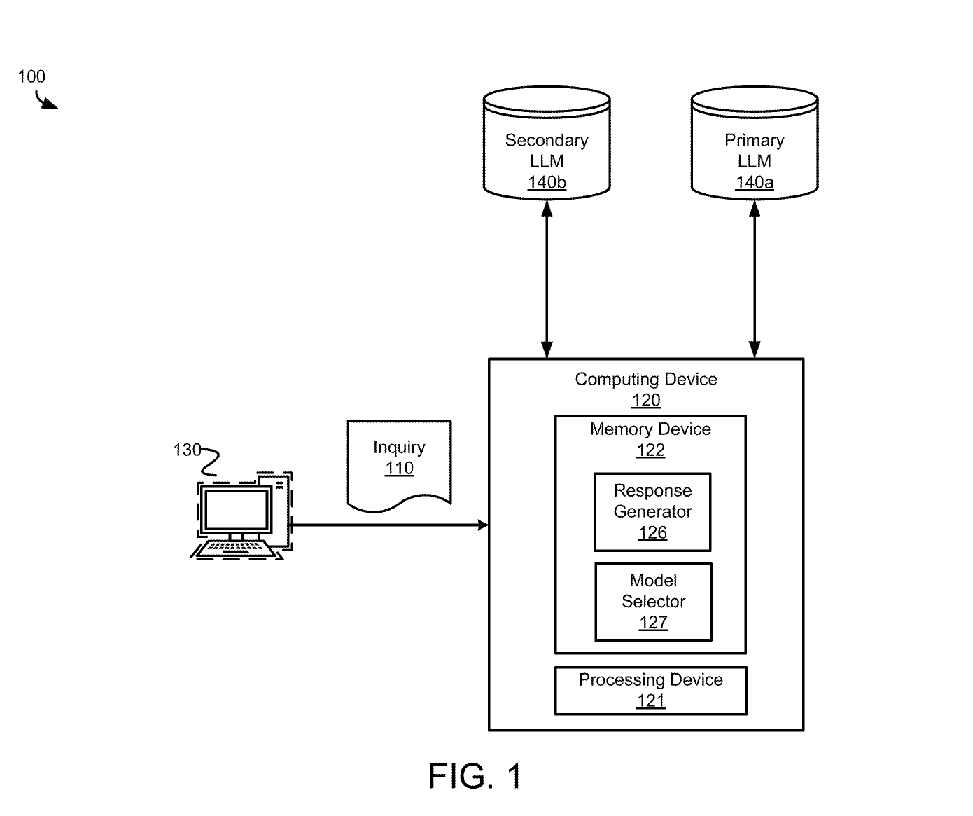

FIG. 1 is a block diagram that illustrates an example computer system 100 for executing an AI application to respond to inquiry 110, according to some implementations. Inquiry 110 may be an initial inquiry by which a user, through client device 130, initiates a conversation to request computing device 120 to generate content in a given topic. Inquiry 110 may alternatively be a follow-up inquiry by which the user provides extra information to supplement the initial inquiry.

Computing device 120 includes processing device 121, such as a processor, and memory device 122, such as a computer drive or a processor cache. Memory device 122 stores program instructions executable by processing device 121. As illustrated, memory device 122 stores instructions for implementing response generator 126 and model selector 127, both of which may be software modules. In some implementations, response generator 126 and model selector 127 are integrated as a software layer with a reverse proxy-based application programming interface (API), which acts as an intermediary between client device 130 and the backend services of the AI application.

Computing device 120 stores, or is communicatively coupled to, primary LLM 140a and secondary LLM 140b. Primary LLM 140a is trained and deployed according to the AI application to generate a response providing the requested content based on inquiry 110. For example, when inquiry 110 contains a question, primary LLM 140a is configured to generate an answer to the question without soliciting further information or asking for clarification. In other words, primary LLM 140a is configured to serve the purpose of the AI application. In some implementations, primary LLM 140a consumes a large amount of computing resources to process inquiries from many users and may be subject to rate limiting in case the number of inquiries exceeds the processing capability supported by the computing resources.

Different from primary LLM 140a, secondary LLM 140b is trained and deployed to generate a response not necessarily to provide the requested content but to keep the user engaged in the conversation, e.g., by asking the user an apparently reasonable follow-up question or requesting the user to provide supplemental information. Some forms of the follow-up questions or requests include: ask the user to disambiguate a term in the inquiry, ask the user to give more context, ask the user about a possible spelling error or variation, ask the user to explain a special term or an acronym or abbreviation, ask the user whether a given data source (e.g., a webpage found through a web search) is relevant to the inquiry, or ask the user about the intent of the inquiry. Because the response generated by secondary LLM 140b is to keep the conversation going instead of providing a response that concludes the conversation, the response generated by secondary LLM 140b may be referred to as an interim response, whereas the response generated by primary LLM 140a may be referred to as a final response.

Secondary LLM 140b may be deployed as a separate LLM from primary LLM 140a and consume separate computing resources. Alternatively or additionally, secondary LLM 140b may share the computing resources with primary LLM 140a but have a smaller, less complex, and/or less resource-consuming architecture. Secondary LLM 140b may implement one or more natural language processing (NLP) algorithms. In some implementations, secondary LLM 140b is configured with a mixture of nested experts (MoNE) model or a symbolic AI model, such as a rule engine that supports NLP.

In some implementations, secondary LLM 140b is trained to perform operations to generate the interim response. As an example, secondary LLM 140b may execute an NLP algorithm to identify one or more words of interest from inquiry 110 and use the words of interest as a basis for generating the interim response. The words of interest may be all nouns in inquiry 110, words with lengths exceeding or below a threshold, words that appear in a data source more or less frequently than a threshold, or words that pertain to a particular topic relating to the AI application. As another example, secondary LLM 140b may execute string distance or soundex based algorithms using a lookup table and identify misspellings as a basis for generating the interim response. As another example, secondary LLM 140b may perform a web search using a search engine and use the interim response to ask whether the search results are relevant to inquiry 110. As another example, secondary LLM 140b may phrase the interim response to ask for more details in order to generate the final response. In some implementations, secondary LLM 140b implements a mechanism, such as randomization, to avoid repeatedly generating an interim response using the same basis (e.g., repeatedly asking the user to confirm spelling). With such mechanism, the conversation is likely to appear more natural (e.g., human-like) to the user.

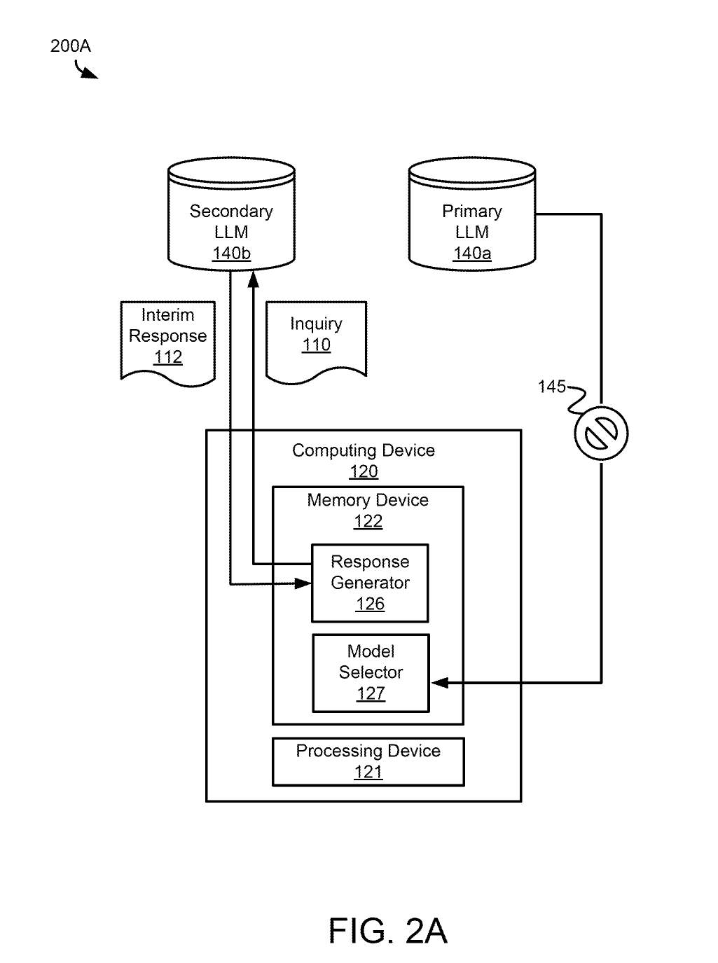

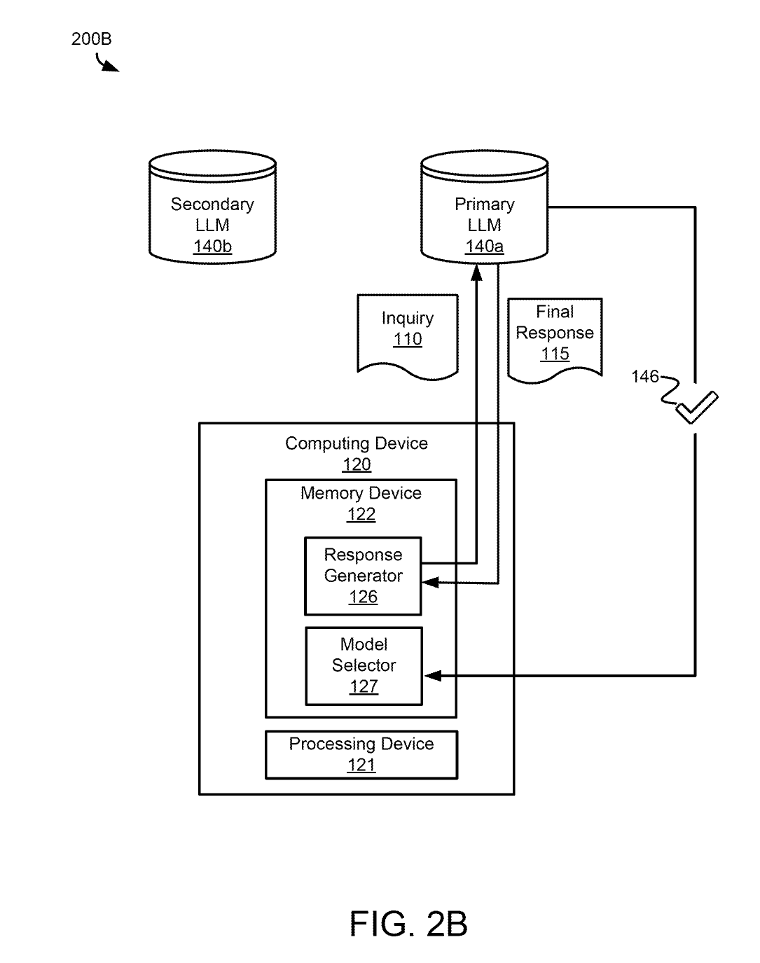

When computing device 120 receives inquiry 110, processing device 121 executes the instructions for model selector 127 to determine whether to provide inquiry 110 to primary LLM 140a or secondary LLM 140b. With the determination, processing device 121 executes the instructions for response generator 126 to obtain a response, whether a final response or an interim response, from the selected LLM. Difference scenarios of LLM selection are described with reference to FIGS. 2A and 2B.

FIGS. 2A and 2B each illustrate an example scenario, 200A and 200B, respectively, in which computer system 100 of FIG. 1 generates a response to inquiry 110 received from a client device, according to some implementations. In both scenarios, model selector 127 monitors the load (e.g., consumption of computing resources) of a neural network associated with primary LLM 140a and determines which LLM to use for generating the response based on the load. For example, model selector 127 may implement a network policy, such as a file containing a series of rules and conditions to describe behaviors of computing device 120 in a variety of scenarios.

In scenario 200A of FIG. 2A, model selector 127 obtains indicator 145 that primary LLM 140a has a high load, e.g., available computing resources associated with primary LLM 140a fail to satisfy a threshold. In this case, model selector 127 applies rate limiting to primary LLM 140a by redirecting inquiry 110 to secondary LLM 140b. As a result, response generator 126 provides the tokens of inquiry 110 to secondary LLM 140b and obtains interim response 112 from secondary LLM 140b for sending back to the client device.

Conversely, in scenario 200B of FIG. 2B, model selector 127 obtains indicator 146 that primary LLM 140a has a low load, e.g., available computing resources associated with primary LLM 140a satisfy the threshold. In this case, model selector 127 directs inquiry 110 to primary LLM 140a. As a result, response generator 126 provides the tokens of inquiry 110 to primary LLM 140a and obtains final response 115 from primary LLM 140a for sending back to the client device.

In some implementations, the user provides a follow-up inquiry to provide additional information as requested in the interim response. Each time computing device 120 receives a follow-up inquiry for the same conversation, model selector 127 repeats the operations described with reference to FIGS. 2A and 2B to determine whether the follow-up inquiry should be directed to primary LLM 140a or secondary LLM 140b. Correspondingly, response generator 126 generates a combined inquiry based on the accumulated conversation history and provides the tokens of the combined inquiry to the selected model. For example, referring to FIG. 2A, after computing device 120 receives a follow-up inquiry based on interim response 112, response generator 126 may combine inquiry 110, interim response 112, and the newly-received follow-up inquiry to generate a combined inquiry and provide the combined inquiry to one of primary LLM 140a and secondary LLM 140b depending on the model selection. The combined inquiry may be a compilation of all information exchanged in the conversation, or may be a summary of the conversation with certain information (e.g., misspelled words) omitted.

In some implementations, computing device 120 iteratively updates inquiry 110 to include the latest conversation history and provides the updated inquiry 110 to secondary LLM 140b until the load associated with primary LLM 140a drops below a threshold. However, having too many iterations of interim responses and follow-up inquiries may negatively affect the user’s experience, making the user feel a waste of time. In view of this, model selector 127 may use a counter to count the number of iterations and stop redirecting inquiry 110 to secondary LLM 140b when the number reaches a certain limit. For example, after asking the user a maximum of three follow-up questions, model selector 127 may stop redirecting inquiry 110 to secondary LLM 140b. Instead, model selector 127 may override the high load indicator 145 and direct inquiry 110 to primary LLM 140a, even if the load of primary LLM 140a is still high. In the meantime, model selector 127 may assign high priority to inquiry 110 and request primary LLM 140a to prioritize the processing of inquiry 110.

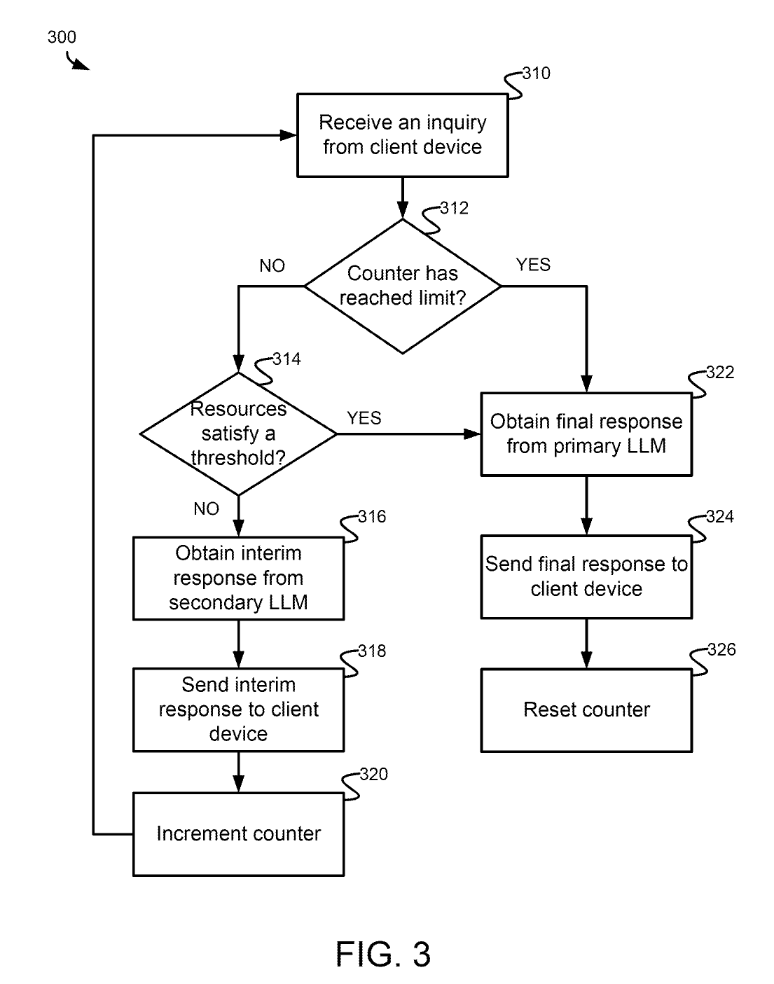

FIG. 3 is a flowchart that illustrates example operations 300 of a computing device executing an AI application with a client device, according to some implementations. Operations 300 may be performed by, e.g., computing device 120 of FIGS. 1, 2A and 2B.

At 310, the computing device receives an inquiry from the client device. The inquiry may be an initial inquiry or a follow-up inquiry, depending on the stage of conversation.

At 312, the computing device determines whether the counter has reached the limit. If the counter has reached the limit, the computing device directs the inquiry to the primary LLM and obtains a final response at 322, regardless of the load of the primary LLM. After obtaining the final response, the computing device sends the final response to the client device at 324 and resets the counter at 326.

If the counter has not reached the limit, the computing device determines, at 312, whether the available computing resources associated with the primary LLM satisfy a threshold. If the answer is YES, which means the load is low, then the computing device directs the inquiry to the primary LLM and obtains a final response at 322. Otherwise, the computing device redirects the inquiry to the secondary LLM and obtains an interim response at 316. After obtaining the interim response, the computing device sends the interim response to the client device at 318 and increments the counter at 320. The computing device then expects to receive a follow-up inquiry in response to the interim response again at 310.

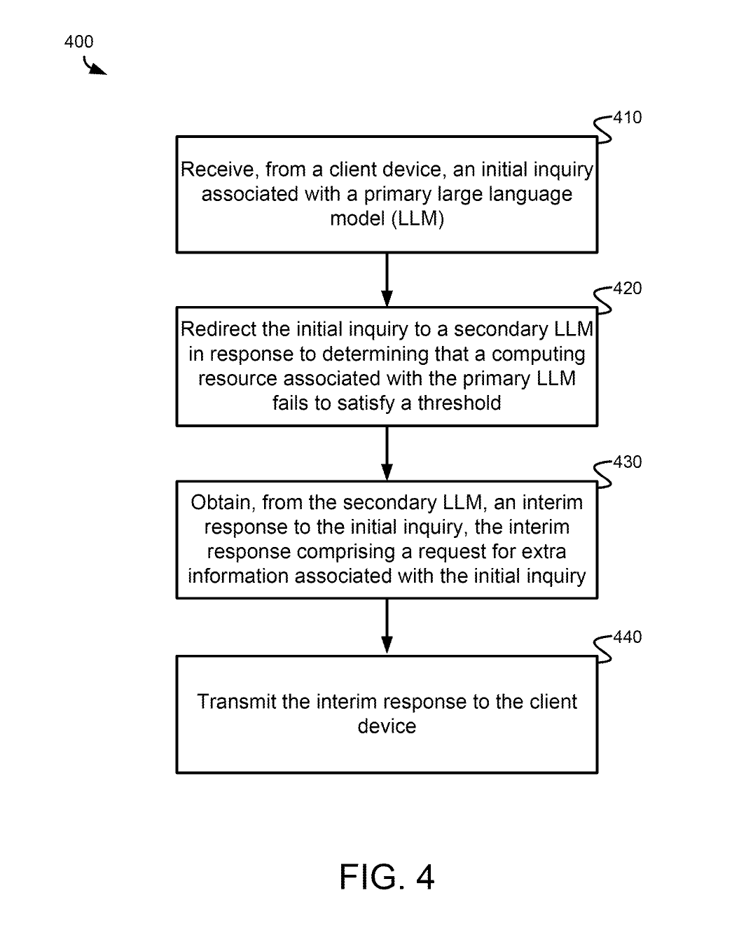

FIG. 4 is a flowchart that illustrates an example method 400, according to some implementations. Method 400 may be performed by, e.g., computing device 120 of FIGS. 1, 2A, and 2B.

At 410, method 400 involves receiving, from a client device, an initial inquiry associated with a primary LLM. The initial inquiry may include one or more tokens to be processed by the primary LLM.

At 420, method 400 involves redirecting, by a processing device, the initial inquiry to a secondary LLM in response to determining that a computing resource associated with the primary LLM fails to satisfy a threshold. In some implementations, redirecting the initial inquiry to the secondary LLM is subject to a condition that a counter does not reach a limit.

At 430, method 400 involves obtaining, from the secondary LLM, an interim response to the initial inquiry. The interim response includes a request for extra information associated with the initial inquiry. In some implementations, obtaining the interim response includes processing the initial inquiry using an NLP model to identify one or more words of interest.

At 440, method 400 involves transmitting the interim response to the client device.

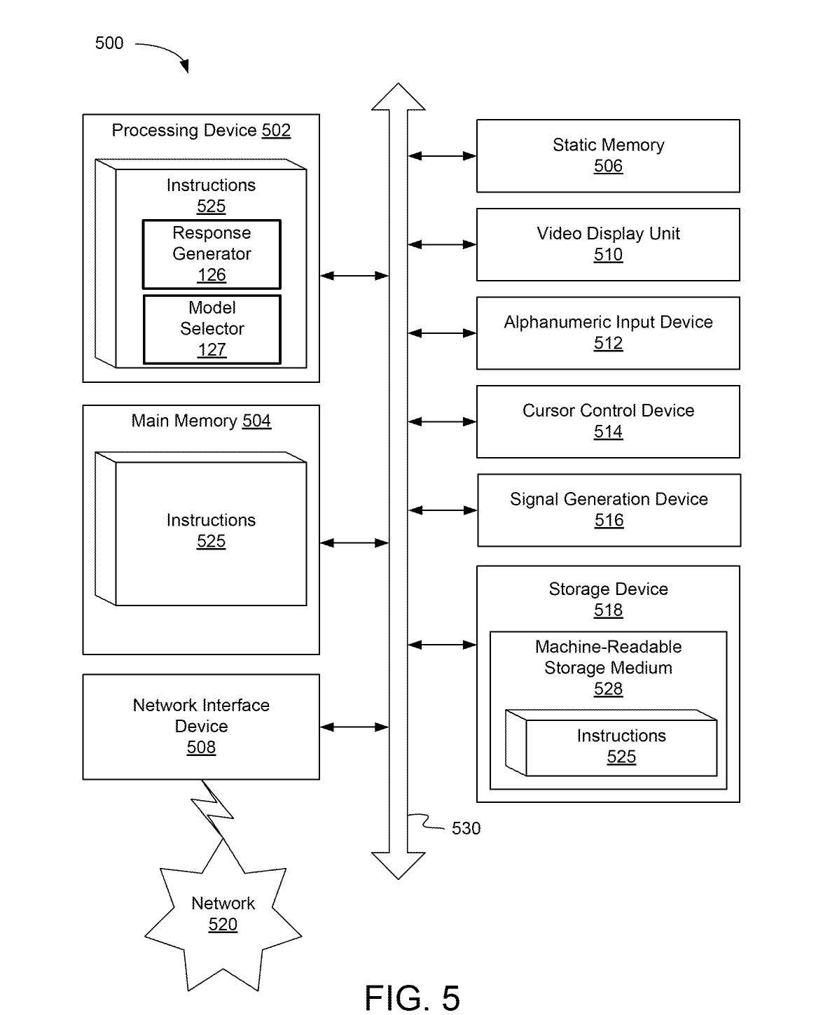

FIG. 5 is a block diagram of an example computing device 500 that may perform one or more of the operations described herein, in accordance with some implementations. For example, computing device 500 may be implemented to perform operations similar to those of computing device 120 of FIG. 1A. Computing device 500 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

Computing device 500 may include a processing device (e.g., a general-purpose processor) 502, a main memory 504 (e.g., synchronous dynamic random access memory (DRAM), read-only memory (ROM)), and a static memory 506 (e.g., flash memory), which may communicate with each other via a bus 530.

Processing device 502 may be provided by one or more general-purpose processing devices, such as a microprocessor, central processing unit, or the like. For example, processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 502 may also include one or more special-purpose processing devices such as an application specific integrated circuit (ASIC), a field programmable gate array (FPGA), a digital signal processor (DSP), network processor, or the like. Processing device 502 may be configured to execute the operations described herein, in accordance with one or more aspects of the present disclosure, for performing the operations and steps discussed herein.

Computing device 500 may further include a network interface device 508, which may communicate with a network 520. Computing device 500 also may include a video display unit 510 (e.g., a liquid crystal display (LCD) or a cathode ray tube (CRT)), an alphanumeric input device 512 (e.g., a keyboard), a cursor control device 514 (e.g., a mouse), and/or a signal generation device 516 (e.g., a speaker). In some implementations, video display unit 510, alphanumeric input device 512, and cursor control device 514 may be combined into a single component or device (e.g., an LCD touch screen).

Processing device 502 may execute instructions 525 to implement response generator 126 and model selector 127. Instructions 525 may be fully or partially stored in main memory 504 or storage device 518. During execution, processing device 502 fetches instructions from main memory 504 via bus 530. Computing device 500 may send or receive instructions 525 to or from network 520 via network interface device 508. In some implementations, computing device 500 further includes storage device 528, which may be a portable storage device that provides storage capacity. Main memory 504 and storage device 528 (if present) may both be implemented with a computer-readable storage medium.

While the term “computer-readable storage medium” is described as a single medium, the term “computer-readable storage medium” should be taken to include a single medium or multiple media (e.g., a centralized or distributed database and/or associated caches and servers) that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media, and magnetic media.

Unless specifically stated otherwise, terms such as “receiving,” “configuring,” “identifying,” “transmitting,” or the like, refer to actions and processes performed or implemented by computing devices that manipulates and transforms data represented as physical (electronic) quantities within the computing device's registers and memories into other data similarly represented as physical quantities within the computing device memories or registers or other such information storage, transmission or display devices. Also, the terms "first," "second," "third," "fourth," etc., as used herein are meant as labels to distinguish among different elements and may not necessarily have an ordinal meaning according to their numerical designation.

The methods and illustrative examples described herein are not inherently related to any particular computer or other apparatus. Various general purpose systems may be used in accordance with the teachings described herein, or it may prove convenient to construct more specialized apparatus to perform the required method steps. The required structure for a variety of these systems will appear as set forth in the description above.

The above description is intended to be illustrative, and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a”, “an” and “the” are intended to include the plural forms as well, unless the context clearly indicates otherwise. It will be further understood that the terms “comprises”, “comprising”, “includes”, and/or “including”, when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular implementations only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure (e.g., circuitry) that performs the task or tasks during operation. As such, the unit/circuit/component can be said to be configured to perform the task, or configurable to perform the task, even when the specified unit/circuit/component is not currently operational (e.g., is not on). The units/circuits/components used with the “configured to” or “configurable to” language include hardware--for example, circuits, memory storing program instructions executable to implement the operation, etc. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure (e.g., generic circuitry) that is manipulated by software and/or firmware (e.g., an FPGA or a general-purpose processor executing software) to operate in manner that is capable of performing the task(s) at issue. “Configured to” may also include adapting a manufacturing process (e.g., a semiconductor fabrication facility) to fabricate devices (e.g., integrated circuits) that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the embodiments and their practical applications, to thereby enable others skilled in the art to best utilize the implementations and various modifications as may be suited to the particular use contemplated. Accordingly, the present implementations are to be considered as illustrative and not restrictive, and the invention is not to be limited to the details given herein, but may be modified within the scope and equivalents of the appended claims.

What is claimed is:

1. A method comprising:
receiving, from a client device, an initial inquiry associated with a primary large language model (LLM);
redirecting, by a processing device, the initial inquiry to a secondary LLM in response to determining that a computing resource associated with the primary LLM fails to satisfy a threshold;
obtaining, from the secondary LLM, an interim response to the initial inquiry, the interim response comprising a request for extra information associated with the initial inquiry; and
transmitting the interim response to the client device.

2. The method of claim 1, further comprising:
receiving, from a client device, a follow-up inquiry in response to the interim response.

3. The method of claim 2, further comprising:
combining the initial inquiry, the interim response, and the follow-up inquiry to generate a combined inquiry;
directing the combined inquiry to the primary LLM in response to determining that the computing resource satisfies the threshold; and
obtaining, from the primary LLM, a final response associated with the initial inquiry.

4. The method of claim 1, further comprising:
determining a number of tokens in the initial inquiry;
determining a load of a neural network associated with the primary LLM; and
determining an availability of the computing resource based on the number of tokens and the load of a neural network.

5. The method of claim 1, further comprising:
counting a total number of a plurality of interim responses to the initial inquiry;
combining the initial inquiry, the plurality of interim responses, and a plurality of follow-up inquiries to generate a combined inquiry; and
directing the combined inquiry to the primary LLM in response to determining that the total number reaches a limit.

6. The method of claim 1, wherein obtaining the interim response comprises processing the initial inquiry using a natural language processing (NLP) model to identify one or more words of interest.

7. The method of claim 1, wherein the request for extra information comprises at least one of:
a request to disambiguate the initial inquiry;
a request to supplement the initial inquiry; or
a request to confirm relevancy of a web search based on the initial inquiry.

8. A system comprising:
a memory; and
a processing device operatively couple to the memory, to:
receive, from a client device, an initial inquiry associated with a primary large language model (LLM);
redirect the initial inquiry to a secondary LLM in response to determining that a computing resource associated with the primary LLM fails to satisfy a threshold;
obtain, from the secondary LLM, an interim response to the initial inquiry, the interim response comprising a request for extra information associated with the initial inquiry; and
transmit the interim response to the client device.

9. The system of claim 8, wherein the processing device is further to:
receive, from a client device, a follow-up inquiry in response to the interim response.

10. The system of claim 9, wherein the processing device is further to:
combine the initial inquiry, the interim response, and the follow-up inquiry to generate a combined inquiry;
direct the combined inquiry to the primary LLM in response to determining that the computing resource satisfies the threshold; and
obtain, from the primary LLM, a final response associated with the initial inquiry.

11. The system of claim 8, wherein the processing device is further to:
determine a number of tokens in the initial inquiry;
determine a load of a neural network associated with the primary LLM; and
determine an availability of the computing resource based on the number of tokens and the load of a neural network.

12. The system of claim 8, wherein the processing device is further to:
count a total number of a plurality of interim responses to the initial inquiry;
combine the initial inquiry, the plurality of interim responses, and a plurality of follow-up inquiries to generate a combined inquiry; and
direct the combined inquiry to the primary LLM in response to determining that the total number reaches a limit.

13. The system of claim 8, wherein, to obtain the interim response, the processing device is further to process the initial inquiry using a natural language processing (NLP) model to identify one or more words of interest.

14. The system of claim 8, wherein the request for extra information comprises at least one of:
a request to disambiguate the initial inquiry;
a request to supplement the initial inquiry; or
a request to confirm relevancy of a web search based on the initial inquiry.

15. A non-transitory computer-readable medium storing instructions that, when executed by a processing device, cause the processing device to:
receive, from a client device, an initial inquiry associated with a primary large language model (LLM);
redirect the initial inquiry to a secondary LLM in response to determining that a computing resource associated with the primary LLM fails to satisfy a threshold;
obtain, from the secondary LLM, an interim response to the initial inquiry, the interim response comprising a request for extra information associated with the initial inquiry; and
transmit the interim response to the client device.

16. The non-transitory computer-readable medium of claim 15, wherein the instructions cause the processing device further to:
receive, from a client device, a follow-up inquiry in response to the interim response.

17. The non-transitory computer-readable medium of claim 16, wherein the instructions cause the processing device further to:
combine the initial inquiry, the interim response, and the follow-up inquiry to generate a combined inquiry;
direct the combined inquiry to the primary LLM in response to determining that the computing resource satisfies the threshold; and
obtain, from the primary LLM, a final response associated with the initial inquiry.

18. The non-transitory computer-readable medium of claim 15, wherein the instructions cause the processing device further to:
determine a number of tokens in the initial inquiry;
determine a load of a neural network associated with the primary LLM; and
determine an availability of the computing resource based on the number of tokens and the load of a neural network.

19. The non-transitory computer-readable medium of claim 15, wherein the instructions cause the processing device further to:
count a total number of a plurality of interim responses to the initial inquiry;
combine the initial inquiry, the plurality of interim responses, and a plurality of follow-up inquiries to generate a combined inquiry; and
direct the combined inquiry to the primary LLM in response to determining that the total number reaches a limit.

20. The non-transitory computer-readable medium of claim 15, wherein, to obtain the interim response, wherein the instructions cause the processing device further to process the initial inquiry using a natural language processing (NLP) model to identify one or more words of interest.
